(19) United States
(12) Patent Application Publication
(10) Pub. No.: US 2008/0319582 A1
(43) Pub. Date: Dec. 25, 2008

(54) Device for In-Line Process Control During the Production of Emulsions or Dispersions

(76) Inventor: Gerd Dahms, Duisburg (DE)

Correspondence Address: CANTOR COLBURN, LLP, 20 Church Street, 22nd Floor, Hartford, CT, 06103, US

(21) Appl. No.: 12/088,327

(22) PCT Filed: Sep. 28, 2005
(86) PCT No.: PCT/EP2005/010480

§ 371 Date: Sep. 2, 2008

(51) Int. Cl. G05B 15/00

(52) U.S. Cl. 700/265

(57) ABSTRACT

Disclosed is a device for on-line process control during the production of emulsions or dispersions. Said device comprises a vessel for accommodating an emulsion or dispersion, a stirring tool located in the vessel for generating a stirring input into the emulsion or dispersion, an apparatus for continuously measuring the stirring input, sensing probes located in the vessel for continuously measuring the temperature and the conductivity of the emulsion or dispersion, and a recording apparatus for continuously recording the stirring input, the temperature, and the conductivity.

### BACKGROUND

The invention relates to a device for in-line process control during the production of emulsions or dispersions, to the use of such a device for determining suitable process parameters for the production of emulsions or dispersions and to a process for determining suitable process parameters for the production of emulsions or dispersions.

The production of emulsions and dispersions is normally performed discontinuously in agitator reactors. In this case, the required quantities of the input materials are metered into a mixing vessel and emulsified or dispersed with a high agitation input. As a rule, high performance agitators are used for this purpose, which permit the generation of cavitation forces. Alternatively, high pressure homogenisation is frequently performed. Control of the emulsions and dispersions produced and control of the process is normally only performed in the finished product of the corresponding mixing load. Continuous control of the production process is normally not possible. Since the product can in each case only be analysed after completion of the corresponding mixing load, the setting of advantageous or optimal process parameters for the production of emulsions and dispersions is difficult. An optimised production is—if at all—only possible in a complex manner involving numerous iterative steps. The determination of the mutual dependence of process parameters and of products obtained as a result thereof, for example via the agitation input, the temperature and the manner of adding the ingredients, is not possible according to known processes.

It is the object of the present invention to provide a device for in-line process control during the production of emulsions or dispersions, as well as a process for determining suitable process parameters for the production of emulsions or dispersions, wherein the drawbacks of the devices and processes known from the state of the art are to be avoided.

### BRIEF SUMMARY

Disclosed herein are a device for in-line process control during the production of emulsions or dispersions, the use thereof, and a process for determining suitable parameters for the production of emulsions or dispersions.

The object is attained by a device according to the invention for in-line process control during the production of emulsions or dispersions, including a vessel for receiving an emulsion or dispersion, an agitating tool located in the vessel for generating an agitation input into the emulsion or dispersion, a device for continuously measuring the agitation input, measuring probes located in the vessel for continuously measuring the temperature and the conductivity of the emulsion or dispersion, and a recording device for continuously recording the agitation input, the temperature and the conductivity.

The device may, for example, serve for the discontinuous production of emulsions and dispersions on a laboratory scale, on a pilot plant scale or on a production scale.

The object is further attained by using such a device for determining suitable process parameters for the production of emulsions or dispersions.

The object is further attained by a process for determining suitable process parameters for the production of emulsions or dispersions, wherein in a device, as described above, the starting materials of the emulsions or dispersions are introduced into the vessel jointly or separately and are mixed by generating an agitation input and wherein the agitation input, the conductivity and the temperature are measured continuously and, where necessary, the agitation input and/or the temperature of the vessel are modified as a function of the measured values obtained.

### BRIEF DESCRIPTION OF THE DRAWINGS

Refer now to the drawings.

FIG. 1 is a cross-sectional view taken through a vessel provided in an embodiment of the device described herein.

FIG. 2 is another cross-sectional view taken through the vessel provided in an embodiment of the device described herein, wherein the cross-sectional view of FIG. 2 is in normal in relation to another.

FIG. 3 shows a plan view onto an embodiment of a vessel.

FIG. 4 illustrates the schematic structure of an insulated stirrer shaft.

FIG. 5 illustrates the schematic structure of the device according to the invention.

FIGS. 6 to 10 show graphs of the conductivity plotted against time of measurement or temperature.

In what follows, each of the figures will be elucidated in more detail.

### DETAILED DESCRIPTION

To start with, the device according to the invention includes a vessel for receiving an emulsion or dispersion or ingredients of an emulsion or dispersion as well as for accommodating measuring probes for continuously measuring the temperature and conductivity of the emulsion or dispersion. Measuring of temperature and conductivity may be performed in a combined measuring probe. In addition, the vessel is designed so as to be able to accommodate an agitating tool. The vessel may be open on one side (at the top) just like in an agitator reactor. This is the normal case. It is also possible to design the vessel so as to be closed on all sides, in which case the vessel is closed apart from inlets and outlets as well as passages for agitators or passages for analytical sensors.

The agitating tool permits the generation of a mechanical agitation input into the emulsion or dispersion. For this purpose, according to one embodiment of the invention, the agitating tool is designed in such a manner as to function without generating cavitation forces and without high pressure homogenisation. In preferred agitating tools appropriate agitating elements are disposed on a revolving stirrer shaft. In this case, the agitating tool comprises at least one agitating element driven by an agitator motor via a rotated stirring shaft. The agitating tool may be represented by so-called rotor/stator systems, wherein a rotor, driven by a motor, is moved. As a rule, the housing serves as a stator, which housing may be provided with internals such as crushers. For example, impellers may be considered as agitators, which may possibly be provided with strippers. Moreover, as an alternative, kneaders and other suitable agitators may be used, such as planetary paddle mixers, anchor stirrers, beam stirrers, propellers, blade stirrers, dissolver disks or Intermig. Other suitable agitator configurations are known to the person skilled in the art.

The agitating tool is preferably operated in such a manner that the agitation input into the emulsion or dispersion takes place without generating cavitation forces and without high pressure homogenisation.

A homogeniser may additionally be provided in (for example, close to the bottom) or as part of the agitating vessel. The vessel may further comprise a circulating arrangement, wherein, for example, a homogeniser may be provided.

In addition, grinding tools such as grinding beads or balls may optionally be provided in the vessel. Suitable grinding tools are known to the person skilled in the art.

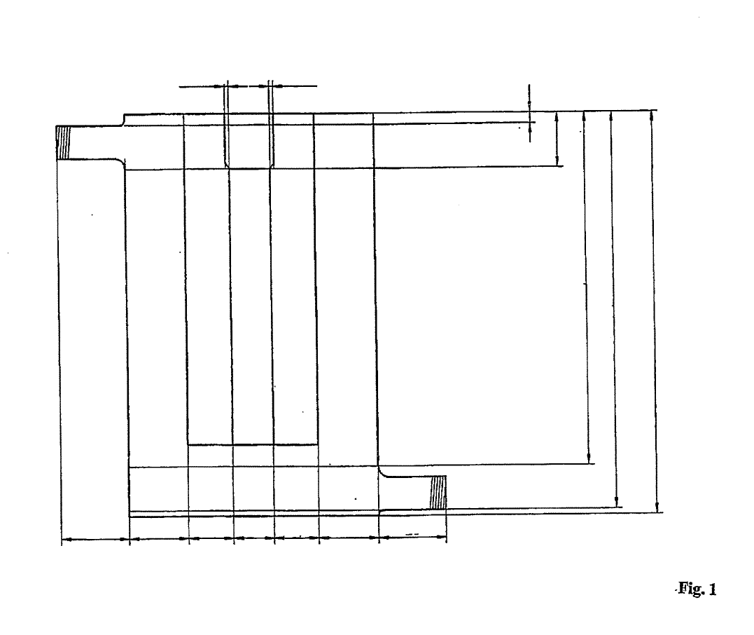

The vessel (mixing vessel) may have any appropriate geometry, as long as it permits suitable intermixing of flowable materials or material mixtures or, respectively, of the phases of the emulsions and dispersions to be produced. Suitable geometries are known to the person skilled in the art. The mixing vessel is preferably of substantially cylindrical internal configuration, the axis of the agitating tool being positioned in the cylinder axis. The measuring probe or measuring probes may be provided directly in the cylindrical space of the vessel. It is also possible to provide two cylindrical vessels, which are positioned parallel to one another and in spaced apart relationship and which are in communication with one another at the lower end in such a manner that through an agitation input intermixing may be performed in both cylindrical vessels. An embodiment of this type is described in the accompanying FIGS. 1 to 3.

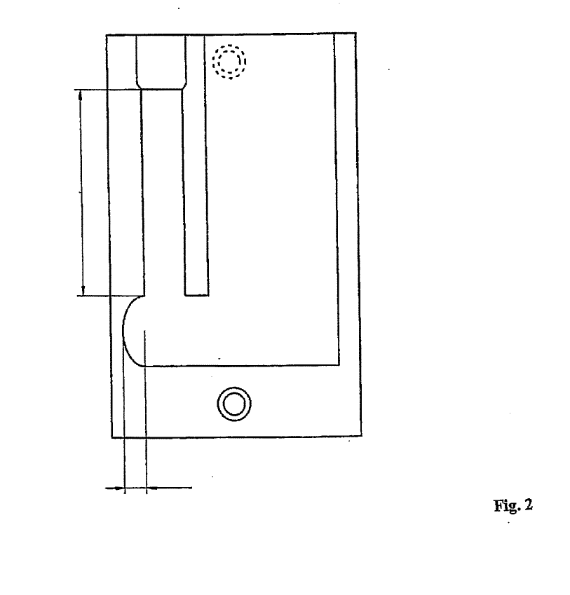

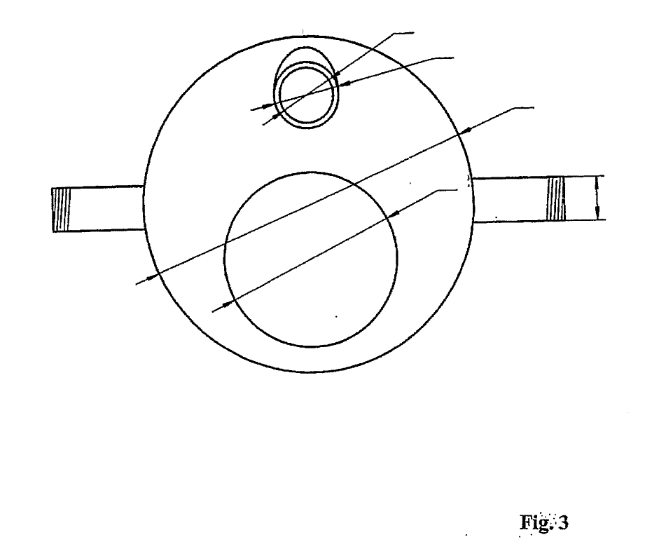

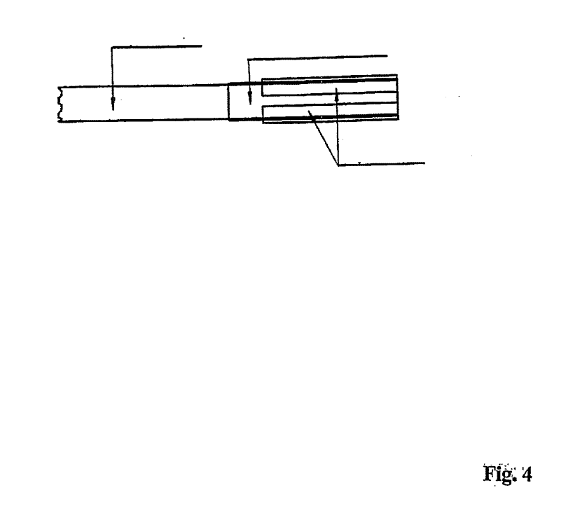

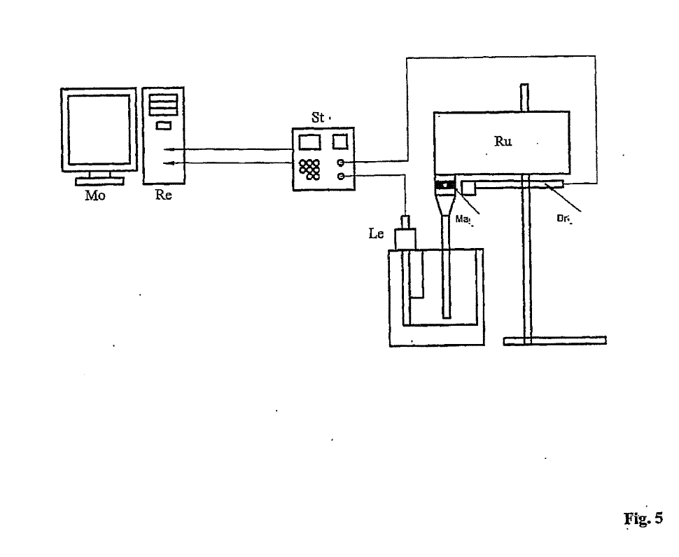

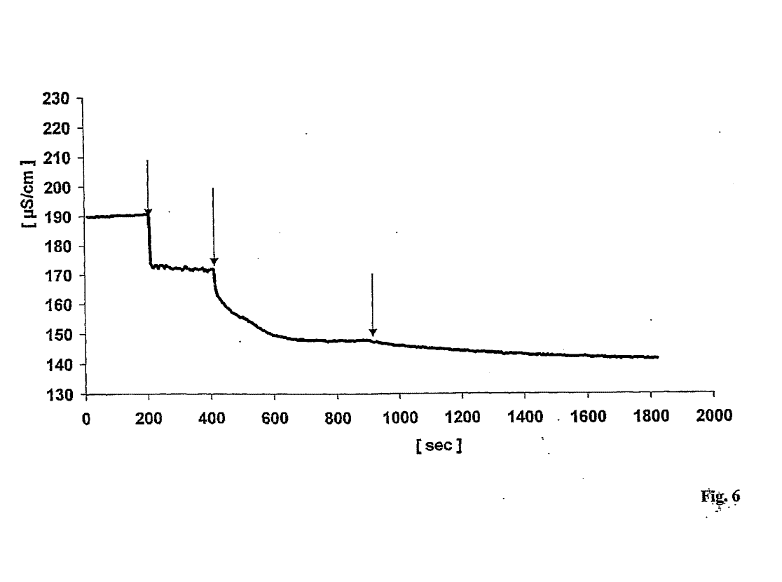

In the drawing, FIGS. 1 and 2 show cross-sectional views, normal in relation to one another, through the vessel according to the invention. FIG. 3 shows a plan view onto the vessel. FIG. 4 shows the schematic structure of the insulated stirrer shaft. FIG. 5 shows the schematic structure of the device according to the invention. FIGS. 6 to 10 show graphs of the conductivity plotted against time of measurement or temperature. In what follows, each of the figures will be elucidated in more detail.

FIG. 1 and FIG. 2 show cross-sections through the vessel provided in the device according to the invention. The vessel includes a jacket for temperature control, through which a temperature control fluid may be passed. At the top left and at the bottom right, FIG. 1 shows the inlet and, respectively, the outlet for the temperature control agent, in particular a cooling or a heating agent. The corresponding inlets and outlets are also shown in FIG. 2 at the bottom and at the top in the form of (dashed) circles, while being visible in FIG. 3 on the left and on the right of the vessel. As shown in FIGS. 1 to 3, two cylindrical recesses of varying diameter are provided in the cooling/heating jacket, the said cylindrical recesses being interconnected in the lower region. This is apparent, in particular, from FIG. 2. FIG. 2 shows on the left-hand side the cylindrical opening with a lesser diameter and on the right-hand side the cylindrical opening with a larger diameter, interconnected in the lower region. The left opening receives the measuring probe for measuring temperature and conductivity, while the right opening accommodates the agitating tool. Both the measuring probe and the agitating tool are inserted from above. The corresponding openings are shown in FIG. 3 from above. In operation, intermixing of the emulsions/dispersions is attained via the agitating tool so that in the left cylindrical opening the mixed emulsion/dispersion flows past the measuring probe as well.

With regard to its size, the (mixing) vessel used according to the invention may be selected according to the respective practical requirements. On a laboratory scale the inner volume (free volume) of the (mixing) vessel is preferably between 50 ml and 10 l, particularly preferably between 100 ml and 5 l, in particular between 300 and 1000 ml. On a pilot plant scale the inner volume is preferably between 5 and 100 l, particularly preferably between 10 and 50 l. On a large-scale industrial or production scale, the volume or, respectively, the intake capacity preferably exceeds 20 tons, for example exceeds 50 tons.

On a laboratory scale, (mixing) vessels may be used, for example, wherein the height of the cylindrical recesses is about 13 cm. The inner diameters of the recesses are, for example, 15 and 48 mm. The entire vessel, including the jacket, has an outer diameter of, for example, 92 mm. In the overall cylindrical embodiment of the vessel shown, the outer diameter, including the jacket, is preferably between 50 and 350 mm. The diameter of the larger cylindrical opening is preferably between 25 and 300 mm.

FIGS. 1 to 3 show a temperature control jacket, through which flows a temperature control agent. Other suitable devices for controlling the temperature of the vessel may, however, also be provided.

It is also possible, for example continuously, to remove a portion of the contents of a mixing vessel on a production scale and to feed it to a device according to the invention. In this case, the agitation inputs may, for example, be adapted to one another in both vessels. It is also possible to determine advantageous process parameters in the device according to the invention and to apply them to the production approximately in real time.

The device according to the invention serves, in particular, for the discontinuous production of emulsions or dispersions. In the process, the vessel shown is charged with the ingredients of the emulsions or dispersions through the apertures provided on top, the finished dispersion or emulsion being discharged through this aperture as well. Alternative geometries of the vessel and of the charging and discharging means are known to the person skilled in the art. The device for in-line process control may also be integrated, for example retrofitted, into already existing conventional agitating vessels on a pilot plant or production scale.

In the event that the agitation input is introduced by an agitating element driven by an agitator motor via a rotated stirring shaft, the stirring shaft along its length preferably comprises an electrical insulation in such a manner that the agitating element and the agitator motor are electrically insulated from one another. An embodiment serving as an example of this insulation is shown schematically in FIG. 4. In this case, R represents the stirring shaft, S a heat-shrinkable hose drawn onto the stirring shaft, consisting of non-conductive synthetic material, and M a metal sleeve pushed onto the heat-shrinkable hose. The electrical insulation of the stirring shaft is brought about by the heat-shrinkable hose located between the stirring shaft and the metal sleeve. The insulation prevents possible interferences with the conductivity/temperature measurement.

FIG. 5 shows the schematic structure of the entire device by way of an example. The agitating tool Ru comprises a magnetic tape Ma, which, in turn, serves as a signal transmitter for a rotational speed sensor Dr. The stirring shaft of the agitating tool projects into the vessel. Furthermore, a measuring probe for measuring the temperature and conductivity Le likewise projects into the vessel. Both the rotational speed sensor and the measuring probe are connected to a control- and recording device St, which, in turn, is triggered by a computer Re, transmitting data to the computer. The control of the temperature and the rotational speed as well as the measurement of the parameters can be checked via a monitor Mo. An input unit, for example a keyboard, by means of which the computer and the control device may be activated, is not shown. Normally, information output media are provided as well. Both the activation of the agitator motor and possibly of pumps or dosing devices for the ingredients of the emulsions or dispersions as well as the capturing of measured values may be activated by a central computer. The evaluation of the measured values (parameters) obtained, is likewise preferably performed by a central computer.

The continuous recording of the agitation input, of the temperature and conductivity may be performed by means of the computer, but also via other suitable media such as printers or plotters. In this context, the agitation input and possibly the temperature control of the vessel are computer-controlled, the continuous recording and, where applicable, the evaluation of the agitation input, the temperature and conductivity being likewise performed in a computer-assisted manner.

The device according to the invention permits to examine completely formulated emulsions and dispersions with regard to their temperature and shearing performance. In addition, critical parameters may be determined and optimised during the production of the emulsions and dispersions. As a rule, the addition of pigment is critical during the production of dispersions. The device according to the invention allows determining in a simple manner how much pigment must be introduced into an emulsion and at what time the addition of pigment should ideally take place. In addition, the formation of an LC-phase in an emulsion may be determined in a time-resolved manner. By varying agitation speeds, scaling-up parameters may be determined during production. The formation of LC-gel networks may be determined by the conductivity at varying temperatures. The effect of low or high rotational speeds may in this case likewise be observed.

During the production of emulsions and dispersions on a pilot plant or production scale, the progress of intermixing or, respectively emulsification or dispersion in each process step and at each point in time of the process without time delay may be analysed in real time, i.e. in-line, and in the agitating vessel itself, so that suitable measures such as adjustment of the agitation input, of the temperature or addition (time, speed, quantity) of emulsion or dispersion components may be triggered in order to optimise the production of emulsions or dispersions.

As a whole, the continuous determination of one or more of the said parameters permits continuous process control and continuous control of the composition of the emulsion or the dispersion. This considerably improves or simplifies quality assurance during production. This is, in particular, of great importance for pharmaceutical products.

The device according to the invention permits, for example, the ideal in-line process control for the production of oil-in-water emulsions or water-based dispersions. During production important parameters such as peripheral speed of the agitator, temperature of the emulsion/dispersion and conductivity of the emulsion/dispersion are continuously recorded automatically. The conductivity data, which are established during the emulsification process, permit a very good interpretation of the emulsion structure as a function of the temperature and agitation intensity. The conductivity of an emulsion/dispersion is in direct relationship with its degree of dispersion, viscosity and structure.

Determination of the Degree of Dispersion by in-Line Conductivity Measurements of Dispersions

As the degree of dispersion increases, the conductivity of an emulsion/dispersion or, respectively, the mobility of ions decreases in the aqueous phase, since with an increasing degree of dispersion the viscosity increases in terms of the relationship according to Einstein. There prevails, therefore, equilibrium between viscosity and the degree of dispersion in an emulsion/dispersion.

If, for example, a pigment is admixed to an o/w-emulsion, the conductivity after addition of this pigment decreases. If the stirring speed during the addition of the pigment is sufficiently high, equilibrium sets in almost immediately after the addition of the pigment. As the addition of the pigment increases, the distribution of the pigment, for a given agitation output, takes longer. If equilibrium ensues only very slowly, it is advisable to increase the peripheral speed. As is apparent from FIG. 6, the in-line measurement by the device according to the invention reflects this process very well. FIG. 6 shows the addition of a pigment to an emulsion. At the locations marked by arrows, 2 g of pigment each were added to the emulsion while being agitated. The conductivity was determined as a function of the measuring time. The curve indicates after which time equilibrium is attained (gradient of the curve approaching zero). It can be seen that after the last addition of the pigment the conductivity continuously decreases further. This means that prior to the last addition of the pigment the maximum quantity of pigment, compatible with the equilibrium, was added at the selected agitation speed. As a result, the present invention permits the indirect measurement of the pigment dispersion and the measurement of the pigment quantity which can be dispersed in an emulsion.

### Emulsions

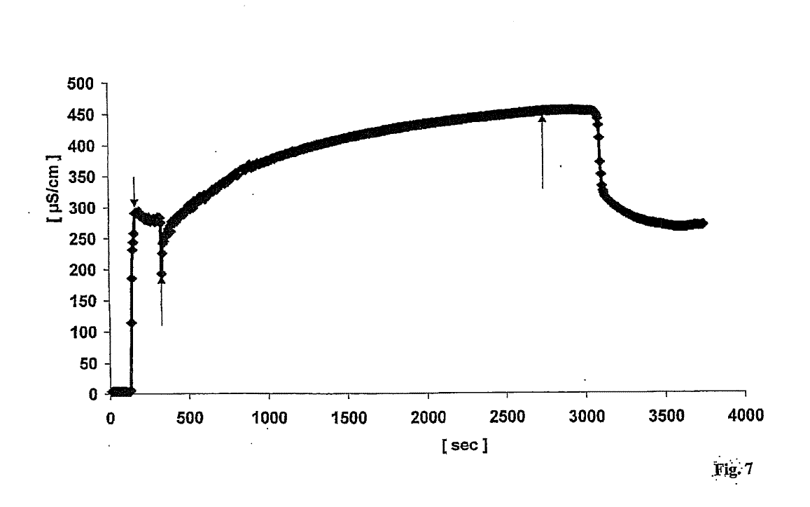

In emulsions the conductivity need, however, not necessarily decrease with an increasing degree of dispersion. Here, it may even increase with an increasing degree of dispersion. This phenomenon occurs, in particular, if ionogenic emulsifiers are used. With an increasing degree of dispersion of the oil droplets, an ever larger interface arises, which is occupied by emulsifiers. By way of the dissociation of the counter-ion of the emulsifier the ion concentration in the aqueous phase and, as a result, the conductivity of the emulsion increases. A typical example of how the conductivity of an o/w-emulsion, stabilised by ionogenic emulsifiers, increases, is shown in FIG. 7. In FIG. 7 the conductivity is plotted against the measuring time. The individual arrows denote different additions during the production of an emulsion. Initially, one proceeds from demineralised water. At the first location marked by an arrow, xanthan gum was added. At the second location marked by an arrow the oil phase was added. At the third location marked by an arrow cooling of the emulsion was started, causing the formation of an LC-phase. The formation of the LC-phase can be readily followed on the basis of the conductivity.

### Detection of Structure Formations

Oil-in-water emulsions are frequently stabilised by liquid crystalline gel networks. Depending on the melting point of the mixing emulsifiers, these are formed in a temperature range below 60° C.

The device according to the invention makes it possible to follow very well as from which temperature the formation sets in and at which temperature it is completed.

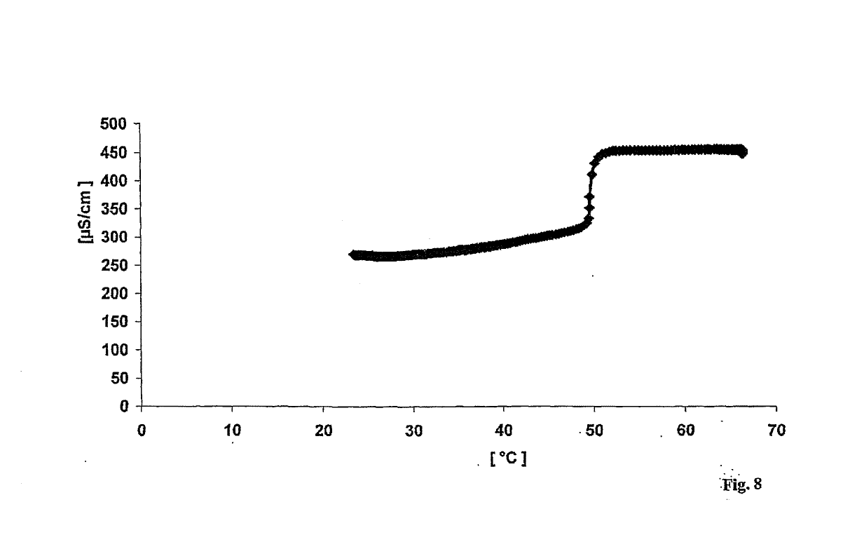

It is therefore possible to detect the critical temperature at which optimal homogenisation should take place or, for example, preservatives should preferably be integrated. FIG. 8 shows the determination of the critical gel network temperature when cooling off. The conductivity has been plotted against the temperature. At low temperatures, an LC-gel network is present. Preferably, preservatives are introduced at those temperatures at which an LC-gel network is present, since smaller quantities are required for good efficacy. At the temperature, at which the conductivity increases, the particle size can be reduced again by subsequent homogenising. The transition temperature to the LC-gel network also permits conclusions with regard to the water resistance, for example of light protection agents. A transition at about 30° C. signifies in this case a composition which is not water resistant.

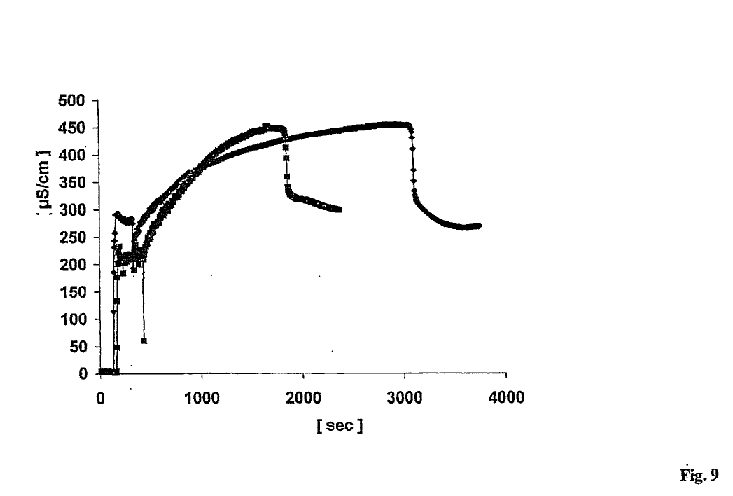

FIG. 9 shows the influence of the agitation speed on the time required for emulsifying. In each case, the conductivity is plotted against the measuring time. For an emulsion which was produced at an agitation speed of 3.15 m/s, a stable emulsion is formed already after about 2000 s, while more than 3000 s are required at an agitation speed of 1.44 m/s. As a result, the device according to the invention allows the determination of optimal agitation speeds and, consequently, scaling-up parameters.

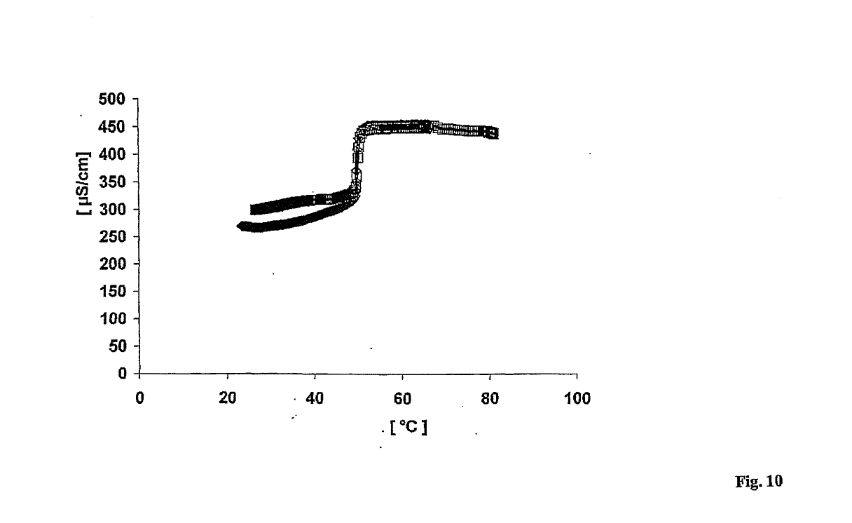

FIG. 10 shows the performance of the LC-gel network formation at different production temperatures. The conductivity is plotted against the temperature. A first LC-gel network was produced at 80° C., a second LC-gel network at 65° C. For the gel network produced at a higher temperature a lower conductivity arises at lower temperatures, as shown in FIG. 10.

The aforegoing examples show that by using the device according to the invention and by using the process according to the invention a multitude of practice-relevant process parameters for the production of emulsions and dispersions can be found. Critical parameters may be determined in a simple manner. By varying the agitation input, the quality of the emulsion may be assessed as a function of the agitation speed. The measuring data, agitation speed, conductivity and temperature are determined directly in the (mixing) vessel.

According to the invention the production of emulsions and dispersions may be examined, having widely diverse volumetric proportions of the disperse phase. Normally, the dependence of the viscosity of an emulsion or dispersion on the volumetric proportion of the disperse phase corresponds to an exponential function. The important viscoelastic region, in which one can operate according to the invention, is the region, where the viscosity very considerably increases with an increasing volumetric proportion. In the case of a dual-phase emulsion, the weight ratio of the phases is selected preferably in a range of from 1:15 to 15:1, preferably 1:5 to 5:1, preferably 1:2 to 2:1, in particular 1:1.5 to 1.5:1. Particularly in the case of oil/water-emulsions (o/w), water/oil-emulsions (w/o) and polyol/oil-emulsions (p/o) the parts by weight of the corresponding phases are preferably in this range.

During the production of the emulsions and dispersions it is also possible to initially work in the highly viscous range and subsequently, by further dilution, in the low viscosity range. The setting up of a fine-particle emulsion or dispersion is in this context attained in the highly viscous range, while the dilution to the final concentration takes place subsequently. For a description of visco-elasticity, reference is made to Römpp, Chemielexikon (chemical encyclopaedia), 9^{th} edition, key word “Viskoelastizität”.

By adhering to the determined quantitative ratios of the two phases a very strong mixing action may be attained even with the input of low shear energies. Without being bound to a theory, the micro emulsion obtained when mixing the phases may be understood as a system of two inter-penetrating networks so that the micro emulsion shows single-phase performance.

The conductivity permits conclusions about the phase volume ratio. Therefore, by measuring the conductivity, changes in the composition of the emulsion or, respectively of the phase volumes can easily be determined. The process control is performed in-line, for example on the production scale, for example up to a ton scale in the range of, for example, 1 to 20 tons of emulsion or dispersion, i.e. continuously during the production process. This makes it possible to react immediately to deviations of the compositions of the emulsions or dispersions so that it is ultimately possible to obtain identical batches. For example, by controlling the agitation input, the production of the emulsions and dispersions may be controlled. The process control is performed in this context by the measurements described, for example directly in the agitator reactor or the mixing vessel thereby resulting in production or quality control, for example for a commercial product.

Besides the temperature control of the (mixing) vessel, the supply of the starting materials for the emulsions and dispersions may likewise be performed in a computer-controlled manner. All process parameters may be controlled and monitored by a central computer. The measured values supplied by the sensors are preferably likewise, as described, fed to the computer and evaluated in a computer-assisted manner.

The (mixing) vessel may be composed of any suitable material. Examples of suitable inert materials are plastics, steels such as V2A- or V4A-steel or copper. Suitable materials or substances are known to the person skilled in the art.

The selection of the agitating tool, of the size of the (mixing) vessel etc. is performed according to practical requirements and can be established by simple preliminary tests. By selecting suitable tools, the device according to the invention can be adapted in a non-complex manner to a multitude of applications. The in-line process control according to the invention may also be integrated into known mixing vessels on the production scale.

The device according to the invention and the process according to the invention may be applied to a multitude of emulsions or dispersions. In particular, emulsions or multiple emulsions are produced according to the invention. Examples are ow-emulsions, wo-emulsions, po-emulsions, multiple emulsions, LC-gels, liposomes or pearly lustre concentrates. According to the invention, a very wide variety of particle sizes is accessible in the emulsions. Apart from normal emulsions, nano-emulsions may be produced as well, comprising emulsion droplets having a mean diameter in the range of from 5 to 1000 nm, preferably of from 15 to 300 nm. The production of nano-dispersions is likewise possible.

For producing an aqueous active substance carrier-nano-dispersion, containing at least one pharmaceutical, cosmetic and/or food-technological active substance, the active substance and the active substance carrier based on lipids and at least one emulsifier forming lamellar structures may initially be mixed at a temperature above the melting point or the softening point. In this case, a phase B is formed. Thereafter this phase B may be mixed with an aqueous phase A at a temperature above the melting point or the softening point of the active substance carrier.

Particles based on lipids are used as active substance carrier particles. These include lipids and lipid-like structures. Examples of suitable lipids are the mono-, di- and triglycerides of saturated straight-chain fatty acids with 12 to 30 carbon atoms such as lauric acid, myristic acid, palmitic acid, stearic acid, arachic acid, behenic acid, lignoceric acid, cerotic acid, melisic acid as well as their esters with other polyvalent alcohols such as ethylene glycol, propylene glycol, mannitol, sorbitol, saturated fatty alcohols with 12 to 22 carbon atoms such as lauryl alcohol, myrestyl alcohol, cetyl alcohol, stearyl alcohol, arachidyl alcohol, behenyl alcohol, saturated wax alcohols with 24 to 30 carbon atoms such as lignoceryl alcohol, ceryl alcohol, cerotyl alcohol, myricyl alcohol. Mono-, di-, triglycerides, fatty alcohols, their esters or ethers, waxes, lipid peptides or mixtures thereof are preferred. In particular, synthetic mono-, di- and triglycerides are used as single substances or in the form of a mixture, for example in the form of a hard fat. Glycerol trifatty acid esters are, for example, glycerol trilaurate, glycerol trimyristate, glycerol tripalmitate, glycerol tristearate or glycerol tribehenate. Suitable waxes are, for example, cetyl palmitate and Cera alba (bleached wax, DAB 9). Polyalkylacrylates, polyalkylcyanoacrylates, polyalkylvinylpyrrolidones, acrylic polymers, polylactic acids or polylactides, sometimes as such, or in combination with polysaccharides, may be used as lipids.

The quantity of active substance carrier particles in relation to the entire aqueous active substance carrier dispersion, is preferably between 0.1 and 30 wt.-%, particularly preferably between 1 and 10 wt.-%. In addition to the lipids, dispersion stabilisers may be used. They may be used, for example, in quantities from between 0.01 and 10 wt.-%, preferably between 0.05 and 5 wt.-%. Examples of suitable substances are surfactants, in particular ethoxylated sorbitane fatty acid esters, block polymers and block copolymers (such as, for example, poloxamers and poloxamines), polyglycerol ethers and polyglycerol esters, lecithins of various origins (for example egg or soy lecithin), chemically modified lecithins (for example hydrated lecithin) as well as phospholipids and sphingo lipids, mixtures of lecithins with phospholipids, sterols (for example cholesterol and cholesterol derivates such as stigmasterol), esters and ethers of sugars or sugar alcohols with fatty acids or fatty alcohols (for example saccharose monostearate), sterically stabilising substances such as poloxamers and poloxamines (polyoxyethylene-polyoxypropylene-block polymers), ethoxylated sorbitane fatty acid esters, ethoxylated mono- and diglycerides, ethoxylated lipids and lipoids, ethoxylated fatty alcohols or fatty acids and charge stabilisers or charge carriers such as, for example, dicetylphosphate, phosphatidylglycerol as well as saturated and unsaturated fatty acids, sodium cholate, sodium glycolcholate, sodium taurocholate or mixtures thereof, amino acids or peptisers such as sodium nitrate (see J. S. Lucks, B. W. Müller, R. H. Müller, Int. J. Pharmaceutics 63, pages 183 to 189 (1990)), viscosity-enhancing materials such as cellulose ethers and -esters (for example, methyl cellulose, hydroxyethyl cellulose, hydroxypropyl cellulose, sodiumcarboxymethyl cellulose), polyvinyl derivates such as polyvinyl alcohol, polyvinyl pyrrolidone, polyvinyl acetate, alginates, polyacrylates (for example carbopol), xanthans and pectins.

Water, aqueous solutions or mixtures of water with water-miscible liquids such as glycerol or polyethylene glycol may be used to serve as the aqueous phase A. Further additional components for the aqueous phase are, for example, mannose, glucose, fructose, xylose, trehalose, mannitol, sorbitol, xylite or other polyols, such as polyethylene glycol as well as electrolytes such as sodium chloride. These additional components may be used in a quantity ranging from 0.5 to 60, for example 1 to 30 wt.-% in relation to the aqueous phase A.

If desired, one can further use viscosity-enhancing materials or charge carriers such as those described in EP-B-0 605 497.

Natural or synthetic products may be used as emulsifiers forming lamellar structures. The use of surfactant mixtures is likewise possible. Examples of suitable emulsifiers are the physiological bile salts such as sodium cholate, sodium hydrocholate, sodium deoxycholate, sodium glycocholate, sodium taurocholate. Animal and plant phospholipids such as lecithins including their hydrated forms as well as polypeptides such as gelatines, including their modified forms, may also be used.

The salts of the sulphosuccinates, polyoxyethylene acid betane esters, acid betane esters and sorbitane ethers, polyoxyethylene fatty alcohol ethers, polyoxyethylene stearic acid esters as well as corresponding mixing condensates of polyoxyethylene-methpolyoxypropylene ethers, ethoxylated saturated glycerides, partial fatty acid glycerides and polyglycides are suitable as synthetic interface-active substances. Biobase^{R} EP and Ceralution^{R} H are examples of suitable surfactants.

Examples of suitable emulsifiers are furthermore glycerol esters, polyglycerol esters, sorbitane esters, sorbitol esters, fatty alcohols, propylene glycol esters, alkylglucosite esters, sugar esters, lecithin, silicon copolymers, wool wax and mixtures thereof or derivates. Glycerol esters, polyglycerol esters, alkoxylates and fatty alcohols as well as iso alcohols may, for example, be derived from ricinoleic acid, 12-hydroxy stearic acid, isostearic acid, oleic acid, linoleic acid, linolenic acid, stearic acid, myristic acid, lauric acid and capric acid. Apart from the said esters, succinates, amides or ethanol amides of the fatty acids may also be present. The ethoxylates, propoxylates or mixed ethoxylates/propoxylates are particularly to be considered as fatty acid alkoxylates.

For the production of the cosmetic emulsions according to the invention emulsifiers are normally used as well. Glycerol esters, polyglycerol esters, sorbitane esters, sorbitol esters, fatty alcohols, propylene glycol esters, alkylglucosite esters, sugar esters, lecithin, silicon copolymers, wool wax and their mixtures and derivates count as examples of suitable emulsifiers. Glycerol esters, polyglycerol esters, alkoxylates and fatty alcohols as well as iso alcohols may, for example, be derived from ricinoleic acid, 12-hydroxy stearic acid, isostearic acid, oleic acid, linoleic acid, linolenic acid, stearic acid, myristic acid, mauric acid and capric acid. Apart from the said esters, succinates, amides or ethanol amides of the fatty acids may also be present. The ethoxylates, propoxylates or mixed ethoxylates/propoxylates are particularly to be considered as fatty acid alkoxylates. Furthermore, emulsifiers may be used which form lamellar structures. Examples of such emulsifiers are the physiological bile salts such as sodium cholate, sodium hydrocholate, sodium deoxycholate, sodium glycocholate, sodium taurocholate. Animal and plant phospholipids such as lecithins including their hydrated forms as well as polypeptides such as gelatines, including their modified forms, may also be used.

The salts of the sulphosuccinates, polyoxyethylene acid betane esters, acid betane esters and sorbitane ethers, polyoxyethylene fatty alcohol ethers, polyoxyethylene stearic acid esters as well as corresponding mixing condensates of polyoxyethylene-methpolyoxypropylene ethers, ethoxylated saturated glycerides, partial fatty acid glycerides and polyglycides are suitable as synthetic interface-active substances. Biobase^{R} EP and Ceralution^{R} H are examples of suitable surfactants.

Lipids and emulsifiers are preferably used in a weight ratio of between 50:1 and 2:1, preferably 15:1 and 30:1.

The active pharmaceutical, cosmetic and/or food-technological substances are used preferably in a quantity, in relation to phase B, ranging from 0.1 to 80 wt.-%, particularly preferably from 1 to 10 wt.-%.

Hereafter, active pharmaceutical substances are listed by way of example, which, for example, may be used in free form, as salt, ester or ether:

Analgesics/anti-rheumatics such as morphine, codeine, piritamide, fentanyl and fentanyl derivates, leyomethadone, tramadol, diclofenac, ibuprofen, indometacine, naproxen, piroxicam, penicillamine; anti-allergics such as pheniramine, dimetindene, terfenadine, asternizol, loratidine, doxylamine, meclozine, bamipine, clemastine; antibiotics/chemo-therapeutics such as polypeptide antibiotics such as colistine, polymyxine B, teicoplanin, vancomycin; anti-malarials such as chinine, halofantrine, mefloquine, chloroquine, virustatics such as ganciclovir, foscarnet, zidovudine, acyclovir and others such as dapsone, fosfomycin, fusafungine, trimetoprim; anti-epileptics such as phenyloin, mesuximide, ethosuximide, primidone, phenobarbital, valproic acid, carbamazepine, clonazepam; anti-mycotics internally such as: nystatin, natarrycin, amphotericin B, flucytoane, miconazol, fluconazol, itraconazol: further externally: clotirmazol, econazol, tioconazol, fenticonazol, bifonazol, oxiconazol, ketoconazol, isoconazol, tolnaftat; corticoids (interna) such as aldosterone, fludrocortisone, betametasone, dexametasone, triamcinolone, fluocortolone, hydroxycortisone, prednisolone, prednylidene, cloprednol, methylprednisolone; dermatological preparations such as antibiotics: tetracycline, erythromycin, neomycin, gentamicin, clindamycin, framycetin, tyrothricin, chlortetracycline, mipirocine, fusidic acid; virustatics as above, in addition: podohyllotoxine, vidarabine, tromantadine; corticoids as above, in addition: amcinonide, flugprednidene, alclometasone, clobetasol, diflorasone, halcinonide, fluocinolone, clocortolone, flumetasone, difluocortolone, fludroxycortid, halometasone, desoximtasone, fluocinolid, fluocortinbutyl, fluprednidene, prednicarbate, desonide; diagnostics such as radioactive isotopes like Te99m, In111 or I131, covalently bound to lipids or lipoids or other molecules or in complexes, highly substituted iodine-containing compounds such as, for example, lipids; haemostyptics such as blood clotting factors VIII, IX; hypnotics, sedatives such as cyclobarbital, pentobarbital, phenobarbital, methaqualone, benzodiazepine (flurazepam, midazolam, netrazepam, lormetazepam, flunitrazepam, trazolam, brotizolam, temazepam, loprazolam); pituitary gland hormones, hypothalamus hormones, regulatory peptides and their inhibitor substances such as corticotrophin, tetracosactide, chorionic gonadotropin, urofollitropin, urogonadotropin, somatropin, metergoline, bromocriptine, terlipressin, desmopressin, oxytocin, argipressin, ornipressin, leuprorelin, triptorelin, gonadorelin, buserelin, nafarelin, goselerin, somatostatin; immuno-therapeutics and cytokines such as dimepranol-4-acetateamidobenzoate, thymopentin, α-interferon, β-interferon, filgrastim, interleucines, azathioprine, ciclosporine; local anaesthetics, such as internally: butanilicaine, mepivacaine, bupivacaine, etidocaine, lidocaine, articaine, prilocaine; externally also: propipocaine, oxybuprocaine, etracaine, benzocaine; migraine preparations such as proxibarbal, lisuride, methysergide, dihydroergotamin, clonidine, ergotamin, pizotifene; narcotics such as methohexital, propofol, etomidate, ketamine, alfentanil, thiopental, droperidol, fentanyl; parathyroid gland hormones, calcium metabolism regulators such as dihydrotachysterol, calcitonine, clodronic acid, etidronic acid; ophthalmic preparations such as atropine, cyclodrine, cyclopentolate, homatropine, tronicamide, scopolamine, pholedrine, edoxudine, idouridine, tromantadine, aciclovir, acetazolamide, diclofenamide, carteolol, timolol, metipranalol, betaxolol, pindolol, befunolol, bupranolol, levobununol, carbachol, pilocarpine, clonidine, neostigmine; psychopharmaceuticals such as benzodiazepine (lorazepam, diazepam), clomethiazol; thyroid gland therapeutics such as 1-thyroxine, carbinazole, thiamazole, propylthiouracil; sera, immunoglobulins, vaccines such as immunoglobulins in general and in particular such as against hepatitis-types, rubella, cytomegaly, rabies; FSME, varicella zoster, tetanus, rhesus factors, immune sera such as botulism-antitoxin, diphtheria, gas gangrene, snake poison, scorpion poison, vaccines such as against influenza, tuberculosis, cholera, diphtheria, hepatitis-types, FSME, rubella, haemophilus influenzae, measles, neisseria, mumps, poliomyelitis, tetanus, rabies, typhus; sex hormones and their inhibitors such as anabolic agents, androgens, anti-androgens, gestagens, estrogens, anti-estrogens (tamoxifen etc.); cystostatics and metastases inhibitors such as alkylants like nimustin, melphalan, carmustin, lomustin, cyclophosphamide, ifosfamid, trofosfamid, chlorambucil, busulfan, treosulfan, predninmustin, thiotepa, antimetabolites such as cytarabin, fluorouracil, methotrexate, mercaptopurin, tioguanin, alkaloids such as vinblastine, vincristine, vindesine; antibiotics such as aclarubicin, bleomycin, dactinomycin, daunorubicin, epirubicin, idarubicin, mitomycin, plicamycin, complexes of side group elements (for example Ti, Zr, V, Nb, Ta, Mo, W, Pt) such as carboplatin, cisplatin and metallocene compounds such as titanocendichloride, amsacrin, dacarbazin, estramustin, etoposide, hydroxycarbamide, mitoxynthrone, procarbazine, temiposide alkylamidophospho lipids (described in J. M. Zeidler, F. Emling, W. Zimmermann and H. J. Roth, Archiv der Pharmazie, 324 (1991), 687)

Ether lipids such as hexadecylphosphocholine, ilmofosine and analogues described in R. Zeisig, D. Arndt and H. Brachwitz, Pharmazie 45 (1990), 809 to 818.

Further suitable active substances are, for example, dichlorphenac, ibuprofen, acetyl salicylic acid, salicylic acid, erythromycin, ketoprofen, cortisone, glucocorticoids.

Active cosmetic substances are furthermore suitable which are, in particular, oxidation or hydrolysis sensitive, such as, for example, polyphenols. Catechins (such as epicatechin, epichatechin-3-gallate, epigallocatechin, epigallocatechin-3-gallate), flavonoids (such as luteolin, apigenin, rutin, quercitin, fisetin, kaempherol, rhametin) isoflavones (such as genistein, daidzein, glycitein, prunetin), cumarines (such as daphnetin, umbelliferon), emodin, resveratrol, orgonin are mentioned here.

Vitamins such as retinol, tocopherol, ascorbic acid, riboflavin, pyridoxine are suitable. Whole extracts from plants are also suitable which, inter alia, contain the above molecules or molecule classes.

According to one embodiment of the invention the active substances are represented by light protection filters. These may be present as organic light protection filters at ambient temperature (25° C.) in liquid or solid form. Suitable light protection filters (UV-filters) are, for example, compounds based on benzophenone, diphenylcyanacrylate or p-aminobenzoic acid. Concrete examples are (INCI- or CTFA-designations) benzophenone-3, benzophenone-4, benzophenone-2, benzophenone-6, benzophenone-9, benzophenone-1, benzophenone-11, etocrylene, octocrylene, PEG-25, PABA, phenylbenzimidazole sulfonic acid, ethylhexyl methoxycinnamate, ethylhexyl dimethyl PABA, 4-methylbenzylidene camphor, butyl methoxydibenzoylmethane, ethylhexyl salicylate, homosalate as well as methylene-bis-benzotriazolyl tetramethylbutylphenol (2,2′-methylene-bis-{6-(2H-benzoetriazol-2-yl)-4-(1,1,3,3-tetramethylbutyl)-phenol}, 2-hydroxy-4-methoxybenzophenone-5-sulfonic acid and 2,4,6-trianilino-p-(carbo-2′-ethylhexyl-1′-oxi)-1,3,5-triazine.

Octyltriazones, avobenzones, octylmethoxycinnamates, octylsalicylates, benzotriazoles and triazines are further organic light protection filters.

According to a further embodiment of the invention active anti-dandruff substances are used as active substances, such as usually occur in cosmetic or pharmaceutical formulations. Piroctone olamine (1-hydroxy-4-methyl-6-(2,4,4-dimethylpentyl)-2(1H)-pyridone is an example hereof; preferably in combination with 2-aminoethanol (1:1). Further suitable agents for treating dandruff are known to the person skilled in the art.

Hydrophilically coated micro-pigments, electrolytes, glycerine, polyethylene glycol, propylene glycol, barium sulphate, alcohols, waxes, metallic soaps, magnesium stearate, vaseline or other ingredients are further possible components of the emulsions. For example, perfumes, perfume oils or perfume aromatics may be added as well. Polyphenols, for example, and compounds derived thereof are suitable active cosmetic substances. Retinol, tocopherol, ascorbic acid, riboflavin and pyridoxine are suitable vitamins.

In addition, for example all oxidation-sensitive active substances such as tocopherol are to be considered as active substances.

According to a further embodiment of the invention, organic dyes are used as active substances, or in lieu of active substances.

The process according to the invention allows the production of all known and suitable water-in-oil-emulsions or oil-in-water-emulsions. For this purpose, the ingredients described for the emulsifiers and further ingredients may be used. The production of polyol-in-oil-emulsions is likewise possible. For this purpose, any suitable polyols may be used.

In the emulsions the proportions of the two main phases may be varied within wide ranges. For example, between 5 and 95 wt.-%, preferably between 10 and 90 wt.-%, in particular between 20 and 80 wt.-% of the respective phases are present, the total quantity resulting in 100 wt.-%.

The p/o-emulsion described may also be emulsified into water or into a water-in-oil-emulsion. In this case, a polyol-in-oil-in-water-emulsion (p/o/w-emulsion) results, containing at least one described emulsion and additionally at least one aqueous phase. Such multiple emulsions may, with regard to their structure, correspond to the emulsions described in DE-A-43 41 113 and DE-A-43 41114.

When introducing the p/o-emulsion according to the invention into water or aqueous systems, the weight ratio of the individual phases may be varied within wide ranges. In the p/o/w-emulsion ultimately obtained, the weight proportion of the p/o emulsion is preferably between 0.01 and 80 wt. %, particularly preferably between 0.1 and 70 wt.-%, in particular between 1 and 30 wt.-% in relation to the entire p/o/w-emulsion.

When introducing the p/o-emulsion into an o/w-emulsion, the proportion of the p/o-emulsion is preferably between 0.01 and 60 wt.-%, particularly preferably between 0.1 and 40 wt.-%, in particular between 1 and 30 wt.-%, in relation to the p/o/w-emulsion ultimately obtained. In the o/w-emulsion, used for this purpose, the oil proportion is preferably between 1 and 80 wt.-%, particularly preferably between 1 and 30 wt.-%, in relation to the o/w-emulsion used. Instead of a p/o-emulsion, a w/o-emulsion may also be introduced, which results in a w/o/w-emulsion. The individual phases of the emulsions may still include conventional ingredients, known for the individual phases. The individual phases may, for example, contain further active pharmaceutical or cosmetic substances, soluble in these phases. The aqueous phase may, for example, contain soluble, organic light protection filters, hydrophilically coated micro-pigments, electrolytes, alcohols etc. Individual or all phases may furthermore contain solids, preferably selected from pigments or micro-pigments, micro spheres, silica gel and similar substances. The oil phase may contain, for example, organically modified clay minerals, hydrophobically coated (micro) pigments, organic oil-soluble light protection filters, oil-soluble active cosmetic substances, waxes, metallic soaps such as magnesium stearate, vaseline, or mixtures thereof. Titanium dioxide, zinc oxide and barium sulphate as well as wollastonite, kaolin, talc, Al₂O₃, bismuth oxychloride, micronised polyethylene, mica, ultramarine, eosin dyes, azo dyes may be mentioned as (micro) pigments. In cosmetics, particularly titanium dioxide or zinc oxide are used as light protection filters and may be applied to the skin particularly smoothly and uniformly by means of the emulsions according to the invention. Micro spheres or silica gel may be used as carriers for active substances, while waxes for example, may be used as the basis for polishes.

The aqueous phase may, moreover, contain glycerine, polyethylene glycol, propylene glycol, ethylene glycol and similar compounds as well as derivates thereof.

The use of conventional expedients and additional substances in the emulsions is known to the person skilled in the art.

Water, aqueous solutions or mixtures of water with water-miscible liquids such as glycerine or polyethylene glycol may be used as the aqueous phase. In addition, electrolytes such as sodium chloride may be contained in the aqueous phase. If desired, viscosity-enhancing materials or charge carriers may further be used, such as described in EP-B-0605 497.

1. Device for in-line process control during the production of emulsions or dispersions, comprising: a vessel for receiving an emulsion or dispersion, an agitating tool located in the vessel for generating an agitation input into the emulsion or dispersion, a device for continuously measuring the agitation input, measuring probes located in the vessel for continuously measuring the temperature and the conductivity of the emulsion or dispersion, and a recording device for continuously recording the agitation input, the temperature and the conductivity.

2. Device according to claim 1, wherein the agitating tool includes an agitating element driven by an agitator motor via a rotating stirring shaft and that the measurement of the agitation input is performed by measuring the rotational speed of the stirring shaft.

3. Device according to claim 2, wherein the stirring shaft along its length comprises an electrical insulation in such a manner that the agitating element and the agitator motor are electrically insulated from one another.

4. Device according to claim 1, wherein the device serves for the discontinuous production of emulsions or dispersions on a laboratory, a pilot plant or a production scale.

5. Device according to claim 1, further comprising a device for temperature control of the vessel.

6. Device according to claim 5, further comprising a computer as a control unit, and wherein the agitation input and the temperature control of the vessel are computer-controlled.

7. Device according to claim 6, wherein the continuous recording and optionally the evaluation of the agitation input, the temperature and conductivity are performed in a computer-assisted manner.

8. Use of a device according to claim 1 for determining suitable process parameters for the production of emulsions or dispersions.

9. Process for determining suitable process parameters for the production of emulsions or dispersions, in a device according to claim 1,
wherein the starting materials of the emulsions or dispersions are introduced into the vessel jointly or separately and are mixed by generating an agitation input,
wherein the agitation input, the conductivity and the temperature are measured continuously, and
wherein, where necessary, the agitation input and/or the temperature of the vessel are modified as a function of the measured values obtained.

10. Process according to claim 9, wherein the variation with time of the conductivity at different agitation inputs or as a function of additions of starting materials of the emulsion or dispersion, or the dependence of the conductivity on the temperature, possibly at different production temperatures, are determined.

11. Process for determining suitable process parameters for the production of emulsions or dispersions, in a device according to claim 7,
wherein the starting materials of the emulsions or dispersions are introduced into the vessel jointly or separately and are mixed by generating an agitation input,
wherein the agitation input, the conductivity and the temperature are measured continuously, and
wherein, where necessary, the agitation input and/or the temperature of the vessel are modified as a function of the measured values obtained.

12. Device according to claim 3, characterised in that it serves for the discontinuous production of emulsions or dispersions on a laboratory, a pilot plant or a production scale.

13. Device according to claim 1, further comprising a computer as a control unit and wherein the agitation input is computer-controlled.
